(19) United States
(12) Patent Application Publication
(10) Pub. No.: US 2021/0277198 A1
(43) Pub. Date: Sep. 9, 2021

(54) COMPOSITION WITH ISOCYANATE COMPATIBLE SILICONE STABILIZER

(71) Applicants: Dow Global Technologies LLC, Midland, MI (US); Dow Silicones Corporation, Midland, MI (US)

(72) Inventors: Noel Mower Chang, Midland, MI (US); Simon Toth, Midland, MI (US); Weston Tulloch, Bay City, MI (US); Anna M. Zink, Midland, MI (US)

(21) Appl. No.: 17/053,905

(22) PCT Filed: Jul. 15, 2019
(86) PCT No.: PCT/US2019/041753

§ 371 Date: Nov. 9, 2020

Related U.S. Application Data
(60) Provisional application No. 62/712,503, filed on Jul. 31, 2018.

(51) Int. Cl. C08J 9/00; C08L 83/12; C08J 9/12; C08G 18/42; C08G 18/76

(52) U.S. Cl. CPC C08J 9/0042; C08L 83/12; C08J 9/122; C08G 2101/00; C08G 18/7671; C08J 2201/022; C08G 18/4211

(57) ABSTRACT

An isocyanate-based foam composition includes a polyol, an isocyanate-containing component and a silicone polyether Got stabilizer having the following structure: (CH₃)₃Si—[OSi(CH₃)₂]ₓ—[OSi(CH₃)(Y)]_{y}—OSi(CH₃)₃ where x is 0 to 15, y is 1 to 2, and Y is (CH₂)ₙO—(CH₂CH₂O)ₑ—(CH₂CH(R))O)ₚ—Z where n is 1 to 10, e is 5 to 15, p is zero to 10, R is —CH₃ or CH₂CH₃ and Z is selected from a group consisting of hydrogen, alkyl, aryl, acyl, and alkyl succinic anhydride groups wherein 20 mole-percent or less of the Z N groups are hydrogen, wherein the ratio of e/x is greater than 0.5 and the number average molecular weight of the silicone polyether stabilizer is less than 4300 grams per mole as determined by nuclear magnetic resonance spectroscopy, and wherein the [OSi(CH₃)₂] and [OSi(CH₃)(Y)] units can be block or random copolymerized

### BACKGROUND OF THE INVENTION

### Field of the Invention

The present invention provides an isocyanate-based foam composition containing a silicone polyether stabilizer.

### INTRODUCTION

Polyurethane (PU) foam and polyisocyanurate (PIR) foam are popular in the building industry for use in thermal insulating applications as well as sealing applications. Both PU and PIR foam are isocyanate-based foams, meaning they are comprise polymers made by reacting molecules having isocyanate functionalities. PU forms by reacting di- or tri-isocyanates with a polyol to form a polymer having organic units joined by carbamate (urethane) links. PIR forms by when polyols (typically polyester polyols) react with isocyanurates (trimerized isocyanate) groups. PIR foam is typically more rigid that PU foam due to the higher degree of crosslinking and is commonly produced as rigid foam board.

Isocyanate-based foams require mixing a polyol with an isocyanate-containing material and reacting them together to form a polymer. Isocyanate-based foams are often prepared using a two-component (2K) system where the isocyanate component is kept apart from the polyol component until they are mixed and foamed. 2K isocyanate foam systems generally require a surfactant in the polyol component to facilitate dispersion of a number of additives that are often included with the polyol component. There are also one-component (1K) systems where oligomers of isocyanate and polyol are formulated together with a blowing agent and upon disposition the formulation foams and polymerizes as moisture in the surrounding air reacts with residual isocyanate groups on the oligomers. In 1K systems, the isocyanate component and polyurethane are oligomerized prior to foam formation so, unlike 2K systems, the isocyanate component and polyurethane are mixed prior to foam formation.

Foam or froth stabilizers (collectively referred to herein simply as “stabilizers”) can be included in isocyanate-based foam systems to enhance foam formation. Care must be taken in selecting stabilizers, and how to introduce stabilizers, to the isocyanate-based foam systems so that the stabilizer does not interfere with surfactants that disperse blowing agent in the polyol-component. Adding a stabilizer to a polyol component if the stabilizer interferes with the surfactant in the polyol component can cause an instability in the polyol component resulting phase separation of polyol components. For example, a surfactant is often used in the polyol component to disperse blowing agent and, if destabilized, can result in phase separation of the blowing agent and inhomogeneous distribution of blowing agent in the foaming composition. Destabilization of polyol component surfactants can result in inhomogeneous foam formulations and ultimately in non-uniform or other undesirable properties during foam formation.

It is desirable for a stabilizer to be compatible with the isocyanate component so it can be mixed with the isocyanate component of 2K systems or mixed with 1K systems without reacting with isocyanate groups needed for polymerization during foaming. Such a desirable stabilizer does not have to be mixed with a polyol component containing a surfactant, thereby avoiding any risk of destabilizing the polyol component.

### BRIEF SUMMARY OF THE INVENTION

The present invention provides a solution to the need for a stabilizer for isocyanate-based foam systems that is compatible with the isocyanate component so it can be mixed with the isocyanate component of 2K systems or mixed with 1K systems without reacting with isocyanate groups needed for polymerization during foaming.

Moreover, the present invention further solves a problem with enhancing thermal insulating capability of a foam made from an isocyanate-based foam system. Surprisingly and unexpectedly, the present invention results in a reduction in thermal conductivity through an isocyanate-based foam made from an isocyanate-based foam system containing the stabilizer of the present invention relative to the same isocyanate-based foam system without the stabilizer.

The present invention is a result of a surprising and unexpected discovery a silicone polyether (SPE) having a molecular weight of 4300 grams per mole (g/mol) or less and having a particular structure to an isocyanate-based foam formulation can act as both a stabilizer and can reduce the thermal conductivity through a resulting form in an isocyanate-based foam formulation. Moreover, the SPE can be added to the isocyanate component when forming the foam formulation that is, the SPE can be blended with the isocyanate prior to being blended with polyol.

The formulation of the present invention can be foamed into a foam having a lower thermal conductivity than a similar foam made in the absence of the SPE or even with other similar SPEs outside the scope of the SPE of the present invention. Moreover, the SPE can be blended with the isocyanate component of the foam formulation prior to blending with the polyol component thereby obviating chance for destabilizing surfactants in the polyol component. Hence, the formulation of the present invention can contain a surfactant, typically an organic surfactant, in the polyol phase as well as the SPE without risking destabilization of the polyol phase.

In a first aspect, the present invention is an isocyanate-based foam composition comprising a polyol, an isocyanate-containing component and a silicone polyether stabilizer having the following structure:

(CH₃)₃Si—[OSi(CH₃)₂]ₓ—[OSi(CH₃)(Y)]_{y}—OSi(CH₃)₃

where x is 0 to 15, y is 1 to 2, and Y is (CH₂)ₙO—(CH₂CH₂O)ₑ—(CH₂CH(R))P)ₚ—Z where n is 1 to 10, e is 5 to 15, p is zero to 10, R is CH₃ or CH₂CH₃ and Z is selected from a group consisting of hydrogen, alkyl, aryl, acyl, and alkyl succinic anhydride groups wherein 20 mole-percent or less of the Z groups are hydrogen, wherein the ratio of e/x is greater than 0.5 and the number average molecular weight of the silicone polyether stabilizer is less than 4300 grams per mole as determined by nuclear magnetic resonance spectroscopy, and wherein the [OSi(CH₃)₂] and [OSi(CH₃)(Y)] units can be block or random copolymerized.

In a second aspect, the present invention is a process for making isocyanate-based foam comprising the step of mixing together the elements of the isocyanate-based foam composition of the first aspect to form a mixture and then allowing the mixture to expand into an isocyanate-based foam.

The formulation of the present invention is useful for making polymeric foam.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to American Society for Testing and Materials; EN refers to European Norm; DIN refers to Deutsches Institut für Normung; and ISO refers to International Organization for Standards.

“Multiple” means two or more. “And/or” means “and, or as an alternative”. All ranges include endpoints unless otherwise indicated.

The present invention is an “isocyanate-based foam composition.” An “isocyanate-based foam composition” is a formulation that can be foamed into an isocyanate-based foam from a component that contains isocyanate functionality and includes 2K and 1K polyurethane and polyisocyanurate foam systems. For avoidance of doubt, “one-shot” systems where separate isocyanate and polyol is added together at the same or approximately the same time as other components during foam formation are considered a “2K” foam system because the isocyanate component and polyol component are kept apart until time of foaming.

The isocyanate-based foam composition of the present invention comprises a polyol. The polyol can be one or more than one polyol, preferably selected from a group consisting of polyether and polyester polyols.

Suitable polyester polyols desirably have an average functionality of 1.8 to 8, preferably 1.8 to 5 and more preferably about 2 to 2.5. The hydroxyl number values for the polyester polyols generally is 15 or more, preferably 30 or more and more preferably 100 or more while at the same time is generally 750 or less, preferably 550 or less, and more preferably 250 or less. Free glycol content of the polyester polyols generally is 0 or more, preferably 2 or more, while at the same time is generally 40 or less, preferably 30 or less, and more preferably 15 or less. The acid number for the polyester polyol is generally 0.2 or greater.

Suitable polyether polyols include linear and branched chain polyether that have a plurality of acyclic ether oxygens and that contain at least 1.8, preferably 3 or more and typically 4 or more while at the same time typically have 8 or fewer isocyanate-reactive groups. The polyether polyols typically have molecular weights, based on their hydroxyl values, ranging from 250 to 7500. “Isocyanate-reactive groups” include hydroxyl (—OH) groups.

The isocyanate-based foam composition of the present invention comprises an isocyanate-containing component. The isocyanate-containing component is desirably selected from organic polyisocyanates including aliphatic, cycloaliphatic, araliphatic, aromatic and heterocyclic polyisocyanates and combinations thereof. “Poly” isocyanates contain on average more than one, preferably 2 or more isocyanate (NCO) groups per molecule. Examples of suitable polyisocyanates include tetramethylene, hexamethylene, octamethylene and decamethylene diisocyanates and their alkyl substituted homologs; 1,2-, 1,3- and 1,4-cyclohexane diisocyanates; 2,4- and 2,6-methyl-cylcohexane diisocyanates; 4,4′ and 2,4′ dicyclohexyl-diisocyanates; 4,4′ and 2,4′-dicylchoexylmethane diisocyanates; 1,3,5-cyclohexane triisocyanates; isocyanatomethylcyclohexane isocyanates; isocyanatoethylcyclohexane isocyanates; bis(isocyanatomethyl)-cylcohexane diisocyanates; 4,4′- and 2,4′-bis(isocyanatomethyl) dicyclohexane; isophorone diisocyanate; 1,2-, 1,3- and 1,4-phylene diisocyanates; 2,4- and 2,6-toluene diisocyanate; 2,4′-, 4,4′- and 2,2′ biphenyl diisocyanates; 2,2′-, 2,4′-, and 4,4′-diphenylmethane diisocyanate; polymethylenepolyphenylene polyisocyanates such as polymeric methylene diphenyl diisocyanate (polymeric MDI); and aromatic aliphatic isocyanates such as 1,2-, 1,3-, and 1,4-xylylene diisocyanates. Additional examples of suitable polyisocyanates include isocyanates terminated quasi-prepolymers. Such quasi-prepolymers are generally prepared by reacting excess organic polyisocyanate or mixtures thereof with a minor amount of an active hydrogen containing compound. Suitable active hydrogen containing compounds for preparing the quasi-prepolymers are those containing at least two active hydrogen-containing groups which are isocyanate reactive. Typifying such compounds are hydroxyl-containing polyester, polyalkylene ether polyols, hydroxyl-terminated polyurethane oligomers, polyhydric polythioethers, ethylene oxide adducts of phosphorous-containing acids, polyacetals, aliphatic polyols, aliphatic thiols including alkane, alkene and alkyne thiols having two or more SH groups; and mixtures thereof.

The isocyanate-based foam composition of the present invention comprises a silicone polyether (SPE) stabilizer. Surprisingly and unexpectedly, including a SPE stabilizer claimed in the present invention in an isocyanate-based foam composition results in a polymeric foam having a lower thermal conductivity than either an isocyanate-based foam composition without SPE stabilizer or an isocyanate-based composition with a similar but out of scope SPE stabilizer. Moreover, the SPE stabilizer of the present invention is compatible with the isocyanate functionality of the isocyanate-containing component. Therefore, the SPE of the present invention can be mixed with the isocyanate-containing component prior to being mixed with a polyol without hindering the foaming performance of the isocyanate-based foam composition.

The SPE stabilizer of the present invention has the following structure (I):

(CH₃)₃Si—[OSi(CH₃)₂]ₓ—[OSi(CH₃)(Y)]_{y}—OSi(CH₃)₃ (I)

where:

x is a number that is zero or higher, preferably one or higher, more preferably two or higher and can be 3 or higher, 4 or higher, 5 or higher, 6 or higher, 7 or higher, 8 or higher, 9 or higher, 10 or higher, 11 or higher, 12 or higher, 13 or higher and even 14 or higher while at the same time is 15 or lower, and can be 14 or lower, 13 or lower, 12 or lower, 11 or lower 10 or lower, 9 or lower, 8 or lower, 7 or lower, 6 or lower, 5 or lower, 4 or lower, and even 3 or lower.

y is a number that is one or higher and at the same time 2 or lower, and Y is independently for each [OSi(CH₃)(Y)] unit selected from structure (II):

(CH₂)ₙO—(CH₂CH₂O)ₑ—(CH₂CH(R))O)ₚ—Z (II)

where:

n is a number that is one or higher, preferably 2 or higher, more preferably 3 or higher and can be 4 or higher, 5 or higher, 6 or higher, 7 or higher, 8 or higher, and even 9 or higher, while at the same time is 10 or lower, 9 or lower, 8 or lower, 7 or lower, 6 or lower, 5 or lower, 4 or lower, and even 3 or lower.

e is a number that is five or higher, preferably 6 or higher, more preferably 7 or higher, even more preferably 8 or higher and can be 9 or higher, 10 or higher, 11 or higher, 12 or higher, 13 or higher and even 14 or higher while at the same time is 15 or lower, 14 or lower, 13 or lower, 12 or lower, 11 or lower, 10 or lower, 9 or lower, 8 or lower, 7 or lower or even 6 or lower.

p is a number that is zero or higher, preferably one or higher, more preferably two or higher and can be 3 or higher, 4 or higher, 5 or higher, 6 or higher, 7 or higher, 8 or higher, even 9 or higher while at the same time is 10 or lower, 9 or lower, 8 or lower, 7 or lower, 6 or lower, 5 or lower, 4 or lower, and even 3 or lower, 2 or lower or even one or lower.

R is CH₃ or CH₂CH₃, and

Z is selected from a group consisting of hydrogen, alkyl, aryl, acyl, and alkyl succinic anhydride groups. Preferably, the Z group is selected from C₁₋₃ alkyl, —C(O)CH₃ and hydrogen, and most preferably C(O)CH₃. 20 mole-percent (mol %) or less, preferably 15 mol %, or less more preferably 10 mol % or less, 5 mol % or less, 3 mol % or less, one mol % or less, 0.5 mol % or less or even 0.25 mol % or less or even 0.1 mol % or less of the Z groups are hydrogen as determined by proton nuclear magnetic spectroscopy.

Additionally, it has been unexpectedly discovered that for the isocyanate-based composition to form a polymeric foam having a thermal conductivity lower than a foam made without SPE, the ratio of e/x must be greater than 0.5, and is preferably 0.7 or greater, more 0.8 or greater, even more preferably one or greater, yet more preferably 2 or greater, and can be 3 or greater, 4 or greater, 5 or greater, 6 or greater, 7 or greater, 8 or greater and at the same time there is no upper limit to the ratio of e/x within the limitations of e and x stated herein because x can be zero.

Adding to the unexpected performance is the fact that the SPE is a small molecule having a number average molecular weight of 4300 grams per mole (g/mol) or less and can be 4000 g/mol or less, 3500 g/mol or less, 3000 g/mol or less, 2500 g/mol or less, 2400 g/mol or less, 2300 g/mol or less, 2200 g/mol or less, 2100 g/mol or less, 2000 g/mol or less, 1750 g/mole or less, 1600 g/mole or less, 1500 g/mol or less, 1250 g/mol or less, 1000 g/mol or less and even 800 g/mol or less. At the same time, the SPE generally has a number average molecular weight of 400 g/mole or more, 500 g/mol or more, 600 g/mol or more, 700 g/mol or more, 750 g/mol or more and can have a molecular weight of 1000 g/mol or more, 1250 g/mol or more, 1500 g/mol or more, 1750 g/mol or more and even 2000 g/mol or more. Unless specifically identified otherwise, molecular weights for SPEs are stated as number average molecular weights with units of grams per mole.

The units of [OSi(CH₃)₂] and [OSi(CH₃)(Y)] can be randomly intermixed with one another as a random copolymer or separate blocks as a block copolymer within the SPE stabilizer. That is, the units of [OSi(CH₃)₂] and [OSi(CH₃)(Y)] can be block or random copolymerized. As a random copolymer, there may be [OSi(CH₃)₂] units on either side of the [OSi(CH₃)(Y)] unit or units. As a block copolymer, there are [OSi(CH₃)₂] units on only one side of the [OSi(CH₃)(Y)] unit or units.

Values for x, y, n, e and p are average values for the number of moles of the designated copolymer unit they correspond to per copolymer molecule and can be decimal values.

Determine the structure and number average molecular weight for SPEs by nuclear magnetic resonance (NMR) spectroscopy using ¹H-NMR, ²⁹Si-NMR and ¹³C-NMR. Collect ¹H-NMR spectra on an Agilent 400MR NMR spectrometer (9.4 T) equipped with a 5 millimeter (mm) OneNMR probe. Prepare samples for ¹H-NMR by dissolving 0.150 grams of sample in one gram of benzene-d6 solvent. Use the following parameters to collect ¹H-NMR spectra: 16 transients with 5 second acquisition time, 15 second relaxation time. Process spectra with ACD/Spectrus Process (2012 release Build 66513) from www.acdlabs.com.

Collect ²⁹Si-NMR and ¹³C-NMR spectra using an Agilent DDR2NMR spectrometer (11.7 T) equipped with a 16 millimeter (mm) silicon-free AutoX probe. Prepare samples for ²⁹Si-NMR and ¹³C-NMR by dissolving 6 grams of sample in 2.7 grams of benzene-d6 solvent with chromium acetylacetonate relaxation agent at 0.05 molar concentration. Use the following parameters to collect ²⁹Si-NMR spectra: 1024 transients, one second acquisition time, 16 second relaxation time. Use the following parameters to collect ¹³C-NMR spectra: 1024 transients, one second acquisition time, 13 second relaxation time. Process spectra with ACD/Spectrus Process (2012 release Build 66513) from www.acdlabs.com.

Use ²⁹Si-NMR spectra to calculate silicone chain parameters. Define a reference with the tallest peak at δ=−22.0 ppm, integral value at δ=7.15+/−0.1 ppm is set to 2. The value of integration at δ=−22.00+/−0.1 ppm provides the chain length (“x”) and the value of integration at δ=−22.45+/−0.1 ppm provides the number of polyether chains (“y”).

Use ¹³C-NMR to calculate polyether chain structure parameters. Set the reference to C₆H₆ middle peak at δ=128.39 ppm, integral value at δ=14.21+/−0.1 ppm is set to “y”, which represent the average number of polyether chains attached to the silicone backbone. Calculate the total number of polyether chains not attached to the silicone backbone by adding the average integral value of signals at δ=98.19+/−0.1 ppm and δ=147.64+/−0.1 ppm (“a1”), the average integral value of signals at δ=100.58+/−0.1 ppm and δ=146.91+/−0.1 ppm (“a2”), and the average integral value of signals at δ=116.34+/10.1 ppm and δ=136.11+/−0.1 ppm (“a3”). The total number of polyether chains is the sum of attached and non-attached polyether chains (t=a1+a2+a3+y). Calculate the average number of ethylene oxide (E0) groups (“e”) in a polyether chain, divide the integral value of signal between δ=68.5 ppm and δ=72.5 ppm by 2 t. Calculate the number of propylene oxide (PO) groups (“p”) in a polyether chain, subtract “y” from the integral value of signal between δ=72.5 ppm and δ=78.5 ppm and then divide by 2 t. Identify the number of linking-CH₂— groups (“n”) by the sum of the integral value signals at δ=14.21+/−0.1 ppm, δ=24.05+/−0.1 ppm and δ=74.17+/−0.1 ppm. Determine the identity of the group “Z” by what signals are present in the NMR. If signal is present at δ=20.95+/−ppm then Z is acyl. If signals are present between δ=66.0+1-0.1 ppm and δ=67.7+/10.1 ppm then Z is hydrogen. If signals are present between δ=56.0+/−0.1 ppm and δ=60.0+/−0.1 ppm then Z is alkyl.

Use 1H-NMR to verify the values of a1, a2, and a3.

Calculate the number average molecular weight based on the above parameters obtained from the NMR spectra. Weight of Z is, for example, 1 if hydrogen, 15 if methyl, 43 if acyl. Number average molecular weight=162+74x+(59+14n+44e+58p+z)y, where “z” is the molecular weight of Z.

The isocyanate-based foam composition can further comprise one or more than one blowing agent. In the broadest scope of the invention, the blowing agent can be any one or any combination of more than one blowing agent used in the manufacture of isocyanate-base foam. For example, the blowing agent can comprise any one or combination of more than one blowing agent selected from a group consisting of hydrocarbons, ethers, esters, water, and carbon dioxide. The hydrocarbons, ethers and esters can be partially or even fully halogenated and include hydrochlorofluorocarbons, chlorofluorocarbons, hydrofluorocarbons, fluorocarbons, hydrochlorofluoro olefins, chlorofluoro olefins, hydrofluoro olefins, and fluoro olefins as well as isopentane, cyclopentane, neopentane, isobutane, and neobutane. Desirably, the blowing agent comprises 20 weight-percent (wt %) or less, preferably 10 wt % or less, even more preferably 5 wt % or less and can comprise 3 wt % or less, 2 wt % or less, one wt % or less 0.5 wt % or less and even can be free of carbon dioxide, where wt % carbon dioxide is based on total weight of blowing agent.

Blowing agents are often present at a concentration of 0.5 wt % or more, preferably one wt % or more and can be 3 wt % or more, 4 wt % or more and even 5 wt % or more of the isocyanate-based foam composition weight while at the same time blowing agents are often present at a concentration of 30 wt % or less, preferably 20 wt % or less and can be 15 wt % or less and even 10 wt % or less. Determine wt % of blowing agent as a combined weight of all blowing agents relative to isocyanate-based foam composition weight.

The isocyanate-based foam composition of the present invention can comprise one or more than one additional surfactant other than the SPE stabilizer. The additional surfactant can be an organic or inorganic surfactant, but is generally an organic surfactant such as one or more than one surfactant selected from polyalkylene oxide surfactants. Polyalkylene oxide surfactants include polyethylene oxide-polybutylene oxide copolymers (EO-BO copolymers) and polyethylene oxide-polybutylene oxide-polyethylene oxide triblock copolymers (EO-BO-EO copolymers).

Additional surfactant can be dispersed in the polyol prior to form a polyol component comprising the additional surfactant and polyol prior to mixing the polyol component with the isocyanate-containing component. Often, as is the case in 2K systems, an additional surfactant and blowing agent are mixed with the polyol to form a polyol component prior to mixing with the isocyanate-containing component. That is, the isocyanate-containing component can serves as a first component and the polyol component can serves as a second component where the first and second component are separate from one another. When the isocyanate-based foam composition comprises a polyol component comprising an additional surfactant that is separate from the isocyanate-containing component, the SPE stabilizer can be mixed into the polyol component, the isocyanate-containing component, or both the polyol component and the isocyanates-containing component. A benefit of the present invention is that the SPE stabilizer does not destabilize an additional surfactant that is present in polyol component. The SPE stabilizer can be present as a blend with the isocyanate-containing component prior to mixing with a polyol component comprising the polyol and an additional surfactant.

The isocyanate-based foam composition can, and desirably does, further comprise a catalyst to catalyze the reaction of the isocyanate functionalities on the isocyanate-containing component with the isocyanate-reactive groups in the polyol. Suitable catalysts include organic and inorganic acid salts of, and organometallic derivatives of, bismuth, lead, tin, iron, antimony, uranium, cadmium, cobalt, thorium, aluminum, mercury, zinc, nickel, cerium, molybdenum, vanadium, copper, manganese, and zirconium as well as phosphines and tertiary organic amines. Examples of catalysts include dibutyltin dilaurate, dibutyltin diacetate, stannous octoate, lead octoate, cobalt naphthenate, trimethylamine, triethylenediamine, N,N,N′,N′-tetramethylethylenediamine, 1,1,3,3,-tetramethylguanidine, N,N,N′N′-tetramethyl-1,3-butanediamine, N,N-dimethylethanolamine, and N,N-diethylethanolamine. Potassium salts of carboxylic acids such as potassium octoate and potassium acetate also serve as suitable catalysts.

The isocyanate-based composition can comprise one or any combination of more than one additional additives, or it may be free of any one or any combination of more than one additional additive. Additional additives include processing aides, viscosity reducers (such as 1-methyl-2-pyrrolidoinone, propylene carbonate), flame retardants, dispersing agents, reinforcing agents, plasticizers, mold release agents, aging and weathering stabilizers, fungistatic and bacteriostatic substances, dyes, fillers and pigments.

For avoidance of doubt, the present invention can be a 1K isocyanate-based foam composition or a 2K isocyanate-based foam composition. The SPE stabilizer can be present in combination with the isocyanate-containing component before and/or during and/or after mixing the polyol with the isocyanate-containing component. Hence, the isocyanate-based foam composition of the present invention can, and desirably does, have SPE stabilizer combined with the isocyanate-containing component in an absence of polyol while at the same time the polyol can have SPE stabilizer combined with it or be free of SPE stabilizer prior combining with the isocyanates-containing component. The SPE stabilizer can be present in the polyol prior to blending the polyol with the isocyanate-containing component while at the same time the isocyanate-containing component can have SPE stabilizer combined with it or be free of SPE stabilizer prior to combining with the polyol. Both the isocyanate-containing component and polyol can be free of SPE stabilizer prior to being combined together and the SPE stabilizer can be combined simultaneously with the isocyanate-containing component and polyol or after combining the isocyanate-containing component and polyol.

The isocyanate-based foam composition can have the characteristics of any combination of limitations described herein for the isocyanate-based foam composition and its elements.

The isocyanate-based foam composition of the present invention is useful for preparing isocyanate-based foam. In the broadest scope the process of preparing an isocyanate-based foam comprising mixing together the elements of the isocyanate-based foam composition to form a mixture and then allowing the mixture to expand into an isocyanate-based foam.

The process of making an isocyanate-based foam can comprise mixing the SPE stabilizer with the isocyanate-containing component either in an absence of the polyol (that is, before the polyol is combined with the isocyanate-containing component) or at the same time as combining the polyol and isocyanate-containing component. For example, the isocyanate-based foam composition can be in the form of a 2K system with the SPE stabilizer combined with the isocyanate-containing component to form a first component and the polyol that is separate from the first component forming a second component that can contain or be free of an additional surfactant and/or SPE stabilizer. The first and second components can then mixed together and allowed to expand into an isocyanate-based foam.

Notably, the isocyanate-based foam composition that is used in forming the isocyanate-based foam can have the characteristics of any combination of limitations described herein for the isocyanate-based foam composition and its elements.

### Examples

The following examples (Exs) and comparative examples (Comp Exs) serve to illustrate the present invention and the unexpected thermal insulating results it provides for an isocyanate-based foam.

SPE Synthesis

Prepare eight different SPEs for use as SPE stabilizers in the Exs and Comp Exs. Start by preparing five different siloxanes and then react those siloxanes with an allyl polyether to form the SPE.

Siloxane Synthesis

Table 1 identifies the materials for preparing the siloxanes:

TABLE 1

| Component | Description | Source |
|---|---|---|
| Polymethylhydrosiloxane, | CAS 63148-57-2 | Gelest, Inc. |
| trimethylsilyl terminated. | | |
| Octamethylcyclotetrasiloxane | CAS 556-67-2 | Gelest, Inc. |
| Hexamethyldisiloxane | CAS 1-7-46-0 | Gelest, Inc. |
| Trifluoromethanesulfonic | CAS 1493-13-6 | Sigma Aldrich |
| acid | | |
| Sodium bicarbonate | CAS 144-55-8 | Sigma Aldrich |

Into a 3-neck round bottom flask equipped with a mechanical stirrer combine the components listed in Table 2 at the concentrations listed depending on the siloxane being made to form a mixture. The concentrations are in wt % relative to combined weight of those components. Flush the reaction flask with nitrogen for several minutes and then shut off the nitrogen flow. Heat the mixture to 60 degrees Celsius (° C.). Add 500 weight-parts per million weight-parts mixture (ppm) trifluoromethanesulfonic acid as a catalyst and continue heating at 60° C. for 8 hours. Neutralize the mixture with sodium bicarbonate (10 grams per milliliter of acid catalyst added). Cool the mixture for 12 hours while stirring. Filter the mixture and remove volatile components from the liquid portion using vacuum distillation at 150° C. at 15 millimeters mercury for 5 hours. Characterize the resulting siloxane using ²⁹Si NMR and FTIR.

TABLE 2

| | Description per | | Wt % Component in Mixture | | |
|---|---|---|---|---|---|
| | Structure (I) | | Polymethylhydrosiloxane, | Octamethyl | |
| Siloxane | x | y | trimethylsilyl terminated | cyclotetrasiloxane | Hexamethyldisiloxane |
| A | 6 | 2 | 17.08 | 63.39 | 19.53 |
| B | 0 | 1 | 29.63 | 0.00 | 70.37 |
| C | 14 | 2 | 9.25 | 80.16 | 10.58 |
| D | 22 | 2 | 6.35 | 86.39 | 7.26 |
| E | 30 | 2 | 4.83 | 89.65 | 5.52 |

Conversion of Siloxane to SPE

React one of the siloxanes with an acetate substituted allyl polyether to form an SPE. The acetate capped allyl polyether is selected from three: (I) acetate capped allyl polyether having an average of seven ethylene oxide groups (for example, TG-101 hydroxyl terminated polyether from Sanyo that has been acetate capped); (II) acetate capped allyl polyether having an average of 12 ethylene oxide groups (for example, TG-506 polyether available from Sanyo; and (III) acetate capped ally polyether having an average of 10 ethylene oxide groups and four propylene oxide groups (for example, NOF Unisafe VG-501 hydroxyl terminated polyether that has been acetate capped).

Acetate capped allyl polyether (II) is acetate capped as is. Modify the hydroxyl terminated allyl polyethers identified for (I) and (III) by the following procedure. Add hydroxyl terminated allyl polyether to a three-neck round bottom flask equipped with a water condenser, a thermal couple, a stir rod with a Teflon® paddle connected to an agitator, and include nitrogen sparging through a septum. Seal all joints with vacuum grease to inhibit oxygen entry. Sparge the polyether with nitrogen at 35-45° C. for one hour. Then, add 1.2 molar excess of acetic anhydride relative to the allyl polyether through the septum via syringe. Heat the resulting mixture to 120° C. for 5 hours under positive nitrogen flow and continuous stirring. Remove volatiles (acetic anhydride and acetic acid) under reduced pressure (approximately 10 millimeters mercury) at 120° C. for two hours and then 150° C. for two hours. Pass the resulting yellow liquid through a five-micron (particle size) nylon filter to obtain the acetate capped allyl polyether.

Table 3 identifies the combination of siloxane and allyl polyether to combine at what wt % relative to their combined weight to prepare eight different SPEs.

TABLE 3

| | Reactants | | | | SPE composition per Structure (I) identifiers | | | | | | | |
|---|---|---|---|---|---|---|---|---|---|---|---|---|
| | | | Acetate | wt % | | | | | | | Mol % | Number Average |
| | | wt % | Substituted | allyl | | | | | | | Z that | Molecular |
| SPE | Siloxane | siloxane | Polyether | polyether | x | y | e | p | n | Z | is H | Weight |
| SPE1 | A | 38.19 | (I) | 61.81 | 6 | 2 | 7 | 0 | 3 | acyl | <1 | 1577.19 |
| SPE2 | A | 23.60 | (II) | 76.40 | 6 | 2 | 12 | 0 | 3 | acyl | <1 | 1933.83 |
| SPE3 | B | 21.39 | (II) | 78.61 | 0 | 1 | 12 | 0 | 3 | acyl | <1 | 789.78 |
| SPE4 | C | 52.86 | (I) | 47.14 | 14 | 2 | 7 | 0 | 3 | acyl | <1 | 2119.56 |
| SPE5 | C | 39.66 | (III) | 60.34 | 14 | 2 | 10 | 4 | 3 | acyl | 15 | 2778.86 |
| SPE6 | C | 44.68 | (II) | 55.32 | 14 | 2 | 12 | 0 | 3 | acyl | <1 | 2443.27 |
| SPE7 | D | 53.93 | (II) | 46.07 | 22 | 2 | 12 | 0 | 3 | acyl | <1 | 3057.36 |
| SPE8 | E | 60.52 | (II) | 39.48 | 30 | 2 | 12 | 0 | 3 | acyl | <1 | 3847.93 |

Combine the siloxane and allyl polyether to form a mixture in a 3-neck flask equipped with a mechanical stirrer, a thermocouple and a water-cooled condenser. Heat the mixture to 70° C. under a nitrogen flow and then add a Karstedt's catalyst via syringe (solution in isopropanol at 5 ppm Pt loading). The reaction mixture becomes turbid and generates heat causing the temperature of the mixture to rise to 90° C. Monitor the reaction progress via tracking the SiH level using infrared (IR) spectroscopy (using a solution of reaction material in tetrachloroethylene) after the temperature increase subsides. The SiH level is determined by taking the peak integration at 2150 cm⁻¹ compared to an external standard of known concentration. If the reaction mixture contains greater than 5% residual SiH, add an additional 5 ppm Pt. Hold the reaction at 90° C. until the SiH level is below 5% of the original amount as monitored by IR spectroscopy, up to 9 hours. Stop the reaction by cooling the mixture down to 25° C. The resulting liquid is clear to slightly hazy golden and is used without further purification.

Isocyanate-Containing Foam Screening

Prepare isocyanate-based foam compositions using the formulation described in Table 4, one for each of the eight SPEs. Prepare a ninth isocyanate-based foam compositions according to the same formulation but without including any SPE to serve as a reference blank. The compositions are in three parts: an A mix (comprising the isocyanate-containing component and any SPE), a B-mix (comprising the polyol, blowing agent and additional additives) and a C-mix (comprising catalysts). Conduct all mixing using an air-driven cowl blade at about 2400 revolutions per minute.

Prepare each mix separately in glass jars by mixing the components together to achieve a homogeneous mixture. Store the B-Mix in a refrigerator until it is used to make foam.

Prepare isocyanate-based foam from each of the isocyanate-based foam compositions. Into an 828 milliliter (28-ounce) paper cup add 241.8 grams of the A-Mix. Briefly mix the B-Mix to ensure homogeneity and then weigh out 106.24 grams into the paper cup with the A-Mix. Mix the contents for 15 second with a wooden stick. Add 6.81 grams catalyst to the cup using a syringe. Mix the contents for another 5 seconds to achieve homogeneity. Pour the resulting mixture into a plastic lined wooden mold of dimensions 22.9 centimeters (9 inches) by 22.9 centimeters (9 inches) by 10.2 centimeters (4 inches) deep. Let the mixture rise and cure for 5 minutes prior to removing the foam from the mold. Allow the foam to cure for 24 hours.

Determine the thermal conductivity of the resulting foam by cutting a 20.3 centimeter (8 inch) by 20.3 centimeter (8 inch) by 2.54 centimeter (one inch) specimen from the foam an immediately evaluating the thermal conductivity according to ASTM C518 using a TA Instruments LaserComp Fox 200 device. Test specimens at 12.5° C. average temperature with plate at zero ° C. and 24° C. Do not apply facers to the foam samples.

Repeat five times for each isocyanate-based foam composition and average the resulting thermal conductivity values to achieve an average thermal conductivity and a standard deviation for the average thermal conductivity.

TABLE 4

| | | |
|---|---|---|
| | | Concentration |
| Component | Description | (wt %) |

A-Mix

| | | |
|---|---|---|
| SPE | (one of SPE1-8, or none) | 0.86 |
| Isocyanate- | polymeric methylene diphenyl diisocyanate (pMDI) having a | 67.60 |
| containing | number average molecular weight of approximately 375 | |
| component | g/mol, a functionality of approximately 3.0, an isocyanate | |
| | equivalent weight of approximately 136.5 grams per | |
| | equivalent, and an isocyanate content of approximately 30.8 | |
| | wt % a viscosity of 700 centipoise at 25° C. (for example, | |
| | PAPI ™ 580 pMDI; PAPI is a trademark of The Dow | |
| | Chemical Company) | |

B-mix

| | | |
|---|---|---|
| Polyol | Polyester polyol having a typical hydroxyl number of 235 | 20.30 |
| | milligrams KOH per gram, a functionality of 2, an equivalent | |
| | weight of 239 grams per equivalent, a viscosity at 25° C. of | |
| | 3500 centipoise (for example TERATE ™ HT5500 polyol; | |
| | TERATE is a trademark of Invista North America S.A.R.L.) | |
| Fire Retardant | tris-(2-chloroisopropyl)phosphate [CAS#1244733-77-4] | 3.81 |
| Organic | Polyethylene oxide-polybutylene oxide-polyethylene oxide | 0.64 |
| Surfactant | trilock copolymer with 62.3 wt % ethylene oxide units, an | |
| | equivalent weight of 3400 grams per equivalent and a nominal | |
| | viscosity of 3300 centipoise at 25° C. (for example, | |
| | VORASURF ™ 504 surfactant; VORASURF is a trademark | |
| | of The Dow Chemical Company). | |
| Blowing agent 1 | Water | 0.32 |
| Blowing agent 2 | Cyclopentane [CAS#287-92-3] | 3.68 |
| Blowing agent 3 | Isopentane [CAS #78-78-4] | 0.27 |

C-Mix

| | | |
|---|---|---|
| Catalyst 1 | Tertiary amine catalyst (for example, POLYCAT ™ 36 brand | 0.10 |
| | catalyst; POLYCAT is a trademark of Air Products and | |
| | Chemicals) | |
| Catalyst 2 | Potassium octoate in diethylene glycol with approximately 15 | 1.53 |
| | wt % potassium (for example, DABCO ™K15 catalyst; | |
| | DABCO is a trademark of Air Products and Chemicals, Inc.) | |
| Catalyst 3 | Potassium acetate in ethylene glycol with approximately 15 | 0.27 |
| | wt % potassium (for example, POLYCAT ™ 46 brand catalyst; | |
| | POLYCAT is a trademark of Air Products and Chemicals) | |

Results

Table 5 identifies the average thermal conductivity and standard deviation for the average thermal conductivity for each of the isocyanate-based foam compositions. Average thermal conductivity is in units of milliWatt per meter*Kelvin (mW/m*K)

TABLE 5

| | | Average Thermal | Standard |
|---|---|---|---|
| Sample | SPE | Conductivity (mW/m*K) | Deviation |
| Comp Ex A | (none) | 23.04 | 0.09 |
| Ex 1 | SPE1 | 22.60 | 0.13 |
| Ex 2 | SPE2 | 22.10 | 0.10 |
| Ex 3 | SPE3 | 22.75 | 0.13 |
| Comp Ex B | SPE4 | 23.79 | 0.28 |
| Ex 4 | SPE5 | 22.43 | 0.14 |
| Ex 5 | SPE6 | 22.53 | 0.13 |
| Comp Ex C | SPE7 | 22.88 | 0.12 |
| Comp Ex D | SPE8 | 23.54 | 0.04 |

The data of Table 5 reveals that isocyanate-based foam compositions comprising SPEs 1, 2, 3, 5 and 6 all resulted in foam having thermal conductivities statistically lower than the foam made without an SPE (Comp Ex A). Each of SPEs 1, 2, 3, 5, and 6 fall within the scope of Structure (I).

In contrast, isocyanate-based foam compositions comprising SPEs 4, 7 and 8 all produced foam having a thermal conductivity statistically equivalent to Comp Ex A or higher than Comp Ex A. Each of SPEs 4, 7 and 8 fall outside the scope of Structure (I) even though they are similar to Structure (I). SPE 4 has an e/x ratio that is equal to 0.5 (Structure (I) require an e/x ratio greater than 0.5). SPEs 7 and 8 have an x value higher than that allowed in Structure (I). SPE 8 also has an e/x ratio that is below 0.5.

1. An isocyanate-based foam composition comprising a polyol, an isocyanate-containing component and a silicone polyether stabilizer having the following structure:
(CH₃)₃Si—[OSi(CH₃)₂]ₓ—[OSi(CH₃)(Y)]_{y}—OSi(CH₃)₃
where x is 0 to 15, y is 1 to 2, and Y is (CH₂)ₙO—(CH₂CH₂O)ₑ—(CH₂CH(R))O)ₚ—Z where n is 1 to 10, e is 5 to 15, p is zero to 10, R is CH₃ or CH₂CH₃ and Z is selected from a group consisting of hydrogen, and —C(O)CH₃ groups wherein 20 mole-percent or less of the Z groups are hydrogen, wherein the ratio of e/x is greater than 0.5 and the number average molecular weight of the silicone polyether stabilizer is less than 4300 grams per mole as determined by nuclear magnetic resonance spectroscopy, and wherein the [OSi(CH₃)₂] and [OSi(CH₃)(Y)] units can be block or random copolymerized.

2. The isocyanate-based foam composition of claim 1, wherein n is 1 to 3, e is 7 to 12, p is zero to 5 and Z is selected from a group consisting of —C(O)CH₃ and hydrogen.

3. The isocyanate-based foam composition of claim 1 or, wherein five mole-percent or less of the Z groups are hydrogen based on total moles of Z.

4. The isocyanate-based foam composition of claim 1, wherein the composition further comprises a blowing agent and less than 20 weight-percent of the blowing agent is carbon dioxide.

5. The isocyanate-based foam composition of claim 1, wherein the composition comprises a surfactant in addition to the silicone polyether stabilizer.

6. The isocyanate-based foam composition of claim 5, wherein the isocyanate-based foam composition is a two-component system with a first component comprising a mixture of the isocyanate-containing component and the silicone polyether stabilizer and with a second component that is separate from the first component and that comprises the polyol and the surfactant.

7. A process for making isocyanate-based foam comprising the step of mixing together the elements of the isocyanate-based foam composition of claim 1 to form a mixture and then allowing the mixture to expand into an isocyanate-based foam.

8. The process of claim 7, comprising mixing the silicone polyether stabilizer with the isocyanate-containing component either in an absence of the polyol or at the same time as with the polyol.

9. The process of claim 8, wherein the isocyanate-based foam composition is a two-component system with a first component comprising a mixture of the isocyanate-containing component and the silicone polyether stabilizer and with a second component comprising the polyol that is separate from the first component and the process includes the step of mixing the first and second component together.
